(19) United States
(12) Patent Application Publication
(10) Pub. No.: US 2025/0235376 A1
(43) Pub. Date: Jul. 24, 2025

(54) ELASTIC TAPPING MASSAGE STRUCTURE AND ELASTIC TAPPING MASSAGE DEVICE

(71) Applicant: SHENZHEN GLOBAL TRADE NETWORK TECHNOLOGY CO., LTD, SHENZHEN (CN)

(72) Inventor: JUNJUN CHEN, SHENZHEN (CN)

(73) Assignee: SHENZHEN GLOBAL TRADE NETWORK TECHNOLOGY CO., LTD, SHENZHEN (CN)

(21) Appl. No.: 19/177,784

(22) Filed: Apr. 14, 2025

Related U.S. Application Data
(63) Continuation of application No. PCT/CN2022/138956, filed on Dec. 14, 2022.

(30) Foreign Application Priority Data
Mar. 20, 2025 (CN) 2025103342422

(51) Int. Cl. A61H 23/00; A61H 23/02

(52) U.S. Cl. CPC A61H 23/006; A61H 23/0254; A61H 2201/149; A61H 2201/1678; A61H 2201/169

(57) ABSTRACT

Disclosed are an elastic tapping massage structure and an elastic tapping massage device. The massage structure includes a drive assembly and an elastic body; the drive assembly includes a drive end, and the drive end is configured to perform oscillating motion; the elastic body includes a connecting end and a motion end, and the connecting end is coupled with the drive end; and the oscillating motion of the drive end causes the elastic body to present a wave-like bending morphology in an axial direction of the elastic body. The present disclosure provides a multi-point tapping massage effect, which is more conducive to increasing the stimulation sensation during the massage.

This application is the continuation in part of international application No. PC T/CN2022/138956, filed on Dec. 14, 2022, which claims priority to Chinese Patent application Ser. No. 20/221,1404960.5, filed on Nov. 10, 2022.

this application also claims priroity to Chinese Patent Application No. 202510 334242.2, filed on Mar. 20, 2025.

The entire contents of aforementioned applications are hereby incorporated by reference in their entirety.

### TECHNICAL FIELD

The present disclosure belongs to the field of massagers, relates to the technology for improving massage comfort, and particularly relates to an elastic tapping massage structure and an elastic tapping massage device.

### BACKGROUND

A massager is a device used for body relaxation, and is widely applied in the fields of medical rehabilitation, health care, and daily relaxation. With the increasing demand for health, the design of massagers has continuously evolved to meet personalized needs of different groups of people. Existing massagers are roughly divided into the following categories according to their operating principles and massage methods:

vibration massagers: usually act on muscle tissues through high-frequency vibrations to promote blood circulation and relieve fatigue; and the vibration massagers are usually simple in structure and widely used in portable massage devices;

kneading and rubbing massagers: an internal mechanical structure of this type of massagers drives a massage head to rotate or move alternately, thereby simulating kneading and rubbing actions of a hand; and

tapping massagers: a massage head or an elastic body is mechanically driven to perform reciprocal tapping action, which helps stimulate acupoints and relax deep muscles.

However, the massage effect provided by the tapping massager is relatively limited. Therefore, the tapping massager needs to be further improved.

### SUMMARY

In order to solve the above technical problems, the present disclosure provides an elastic tapping massage structure and an elastic tapping massage device.

In order to achieve the above objectives, the present disclosure adopts the following technical solutions:

the present disclosure provides an elastic tapping massage structure, including:

a drive assembly, which includes a drive end, and the drive end is configured to perform oscillating motion;

an elastic body, which includes a connecting end and a motion end; where

the connecting end is coupled with the drive end; and

the oscillating motion of the drive end causes the elastic body to present a wave-like bending morphology in an axial direction of the elastic body.

Preferably, the motion end of the elastic body is a flat tapping head.

Preferably, the motion end is sectioned into a plurality of flaps in a length direction, and a gap is formed between adjacent flaps.

Preferably, a width direction of the flaps is perpendicular to an oscillating direction of the oscillating motion.

Preferably, a number of the flaps is 2, and each flap is flap-shaped.

Preferably, a Shore hardness of the drive end is greater than a Shore hardness of the elastic body.

Preferably, mass distribution per unit length of the elastic body near the motion end is greater than mass distribution per unit length at the connecting end.

Preferably, the motion end is a free end.

Preferably, the drive assembly can output:

a first driving frequency; and

the first driving frequency drives the elastic body to form a waveform that approximates a sine wave during the oscillating motion.

Preferably, the waveform that approximates a sine wave has at least 2 wave crests.

Preferably, a length of the elastic body is L, and L≥2 cm.

Preferably, the drive assembly includes:

a drive motor and an eccentric connecting structure;

where an operating end of the drive motor is connected to the eccentric connecting structure; and the eccentric connecting structure is connected to the drive end.

Preferably, the eccentric connecting structure is an eccentric cam.

Preferably, the drive end is a sheet structure;

the sheet structure is arranged as a curvature.

Preferably, the drive end includes:

a first end and a second end;

where the first end is the end away from the drive motor;

the second end is the end near the drive motor; and

the second end is connected to the eccentric cam.

Preferably, the second end is provided with a coupling slot that slides in cooperation with the eccentric cam.

Preferably, the drive end is provided with a hinged portion, and the hinged portion includes:

a mounting hole and a rotating shaft;

where the mounting hole is formed at a position near the second end; and

the rotating shaft is rotatably connected to the mounting hole.

Preferably, an overall length of the drive end is M, and M≤0.5×L.

The present disclosure further provides an elastic tapping massage device, including a housing and further including:

a drive assembly, which includes a drive end, and the drive end is configured to perform oscillating motion;

an elastic body, which includes a connecting end and a motion end; where

the connecting end is coupled with the drive end;

the oscillating motion of the drive end causes the elastic body to present a wave-like bending morphology in an axial direction of the elastic body;

a cavity having a first opening is formed on the housing; the elastic body is arranged in the cavity; and

when the elastic body presents a wave-like bending morphology, a curved portion of the elastic body can protrude from the cavity through the first opening; preferably, the cavity has a second opening;

when the elastic body presents a wave-like bending morphology, a curved portion of the elastic body can protrude from the cavity through the second opening.

The present disclosure provides an elastic tapping massage structure and an elastic tapping massage device, which have the following beneficial effects:

compared with the single-point tapping structure in the prior art, the present disclosure provides a multi-point tapping massage effect, which is more conducive to increasing the stimulation sensation during the massage; and

for some sensitive areas, such as a G-spot, its location varies from person to person, the single-point tapping structure in the prior art is not easy to locate its position accurately, resulting in a weak massage effect on the G-spot. In contrast, by forming the plurality of wave crests, the present disclosure can more effectively locate the G-spot and deliver a more precise massage.

### BRIEF DESCRIPTION OF THE DRAWINGS

FIG. 1 is a first structural diagram of an elastic tapping massage structure according to the present disclosure.

FIG. 2 is a second structural diagram of an elastic tapping massage structure according to the present disclosure.

FIG. 3 is a first schematic diagram of assembly of an elastic tapping massage structure according to the present disclosure.

FIG. 4 is a second schematic diagram of assembly of an elastic tapping massage structure according to the present disclosure.

FIG. 5 is a third schematic diagram of assembly of an elastic tapping massage structure according to the present disclosure.

FIG. 6 is a fourth schematic diagram of assembly of an elastic tapping massage structure according to the present disclosure.

FIG. 7 is a fifth schematic diagram of assembly of an elastic tapping massage structure according to the present disclosure.

FIG. 8 is a structural diagram of a drive assembly of an elastic tapping massage structure according to the present disclosure.

FIG. 9 is a schematic diagram of assembly of a drive motor and an eccentric cam of an elastic tapping massage structure according to the present disclosure.

FIG. 10 is a perspective view of an elastic tapping massage device according to the present disclosure.

FIG. 11 is a front view of an elastic tapping massage device according to the present disclosure.

Reference numerals in the accompanying drawings:

1. drive assembly; 101. motor end; 1011. drive motor; 1012. eccentric cam; 102. drive end; 1021. first end; 1022. second end; 1023. coupling slot; 1024. mounting hole; 1025. rotating shaft; 2. elastic body; 201. connecting end; 2011. coupling hole; 202. motion end; 2021. flap; 2022. gap; 3. housing; 301. cavity; 302. first opening, 303. second opening.

### DETAILED DESCRIPTIONS OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. All the other embodiments obtained by those of ordinary skill in the art based on the embodiments in the present disclosure without creative efforts shall fall within the scope of protection of the present disclosure.

With reference to FIGS. 1-11, specific embodiments provided by the present disclosure are as follows:

As shown in FIGS. 1-3, this embodiment provides an elastic tapping massage structure for human body massage, which is suitable for massaging parts such as the skin or acupoints.

The elastic tapping massage structure includes a drive assembly 1, and the drive assembly 1 includes a motor end 101 and a drive end 102.

As shown in FIGS. 3, 8, and 9, specifically, the motor end 101 includes a drive motor 1011 and an eccentric connecting structure. The drive motor 1011 provides rotational power, and is connected to the drive end 102 via the eccentric connecting structure. The eccentric connecting structure mainly consists of an eccentric cam 1012, and the eccentric cam 1012 is directly connected to an output shaft of the drive motor 1011 to convert rotational motion into reciprocating motion.

Specifically, the drive end 102 includes a drive rod or a drive piece. The drive rod has a first end 1021 and a second end 1022, where the first end 1021 is an end away from the motor end 101 and is configured to perform tapping action; and the second end 1022 is an end near the motor end 101, and is provided with a coupling slot 1023 that slides in cooperation with the eccentric cam 1012 to achieve power transmission. An overall shape of the drive rod can be designed as a straight line or an arc according to actual needs, a mounting hole 1024 is formed in a middle part of the drive rod, a rotating shaft 1025 is assembled in the hole and configured to support the drive rod and define its motion trajectory.

The elastic tapping massage structure further includes an elastic body 2. Specifically, the elastic body 2 includes a connecting end 201 and a motion end 202, and the connecting end 201 is coupled with the first end 1021 of the drive rod through a rod body. For example, a coupling hole 2011 is formed inside the connecting end 201, the rod body is inserted into the coupling hole, such that oscillating motion of the rod body can be synchronously transmitted to the connecting end 201, and the connecting end is driven to oscillate synchronously.

Specifically, the oscillating motion refers to reciprocating oscillation about a fixed axis in a specific plane.

The motion end 202 is a free end, that is, the moving end 202 is not connected to or restricted by any structure. Further, the motion end 202 and the connecting end 201 are an integrally formed structure, and the structure is continuous without obvious boundaries as a whole. A portion of the elastic body 2 extending from the first end 1021 in a direction away from the first end 1021 is considered the motion end 202 of the elastic body 2.

Specifically, when the drive rod or the drive piece oscillates, the connecting end 201 is driven to oscillate synchronously. At the same time, the oscillating motion of the drive end 102 is transmitted to the motion end 202 through the connecting end 201, such that the elastic body 2 presents a wave-like bending morphology as a whole.

Specifically, the wave-like bending morphology refers to a state of motion in which the elastic body 2 transmits power through the connecting end 201 under the oscillating motion of the drive end 102, such that the elastic body 2 undergoes a repeated deformation as a whole in a preset direction (perpendicular to a direction of a tapping surface) with fixed frequency and amplitude.

For example, the frequency of the wave-like bending is 10-50 Hz, and the amplitude of the wave-like bending is 10%-30% of the length of the elastic body 2.

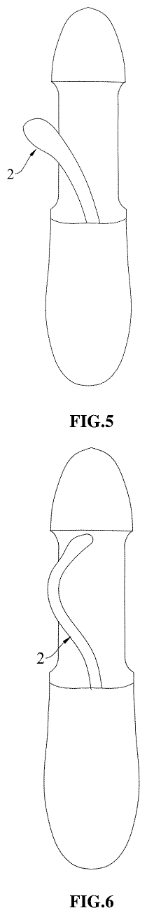

As shown in FIGS. 4 and 5, one manifestation of the wave-like bending morphology is that the elastic body 2 bends in an arc shape only in a specific area (not a whole), and the remaining parts remain nearly straight or slightly deformed.

Specifically, a bending region is located in a local segment of the elastic body 2 near the drive end 102 or the motion end 202 (for example, within ⅓ of a length from the drive end 102). A radius of curvature is 5-20 mm, and a bending angle is 30°-90°.

Preferably, the wave-like bending morphology includes a local curvature bending of the elastic body 2 under the oscillating action of the drive end 102, which is specifically manifested as follows:

the bending region is located within ⅓ of the length of the elastic body 2 near the drive end 102, with a curvature radius of 8-15 mm and a bending angle of 45°-75°; the curvature is generated at a frequency of 20-60 Hz, and the elastic body 2 returns to an initial straight state after each bending; and

the morphology transmits driving force through local deformation, thereby reducing an overall fatigue loss of the elastic body 2.

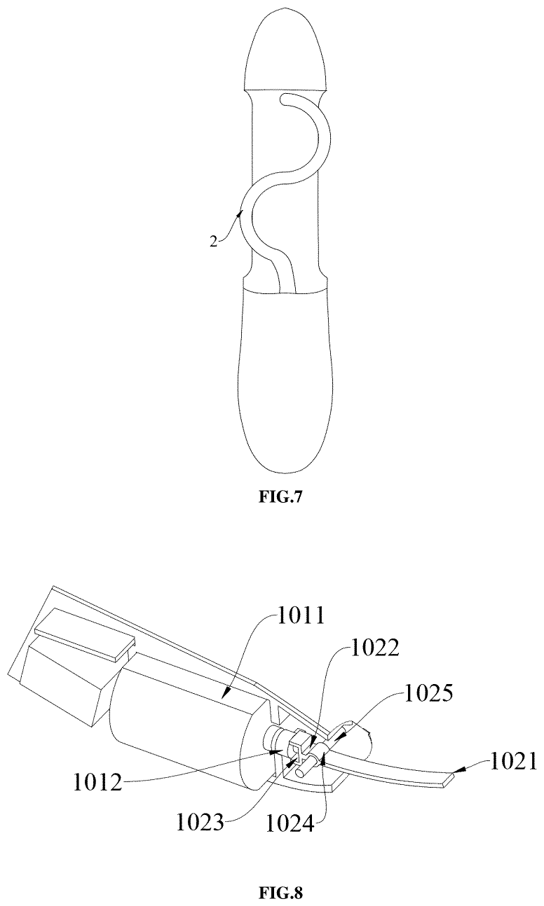

As shown in FIG. 6, another manifestation of the wave-like bending morphology is that the elastic body 2 forms a single consecutive wave crest (similar to one half-period of a sine wave) as a whole, and a position of the wave crest can be fixed or migrated.

Specifically, the position of the wave crest is located in a middle part of the elastic body 2 or near the motion end 202 (such as at 40%-60% of a total length). A height of the wave crest is defined as a vertical distance from an apex to a flat state (such as 3-5 times a thickness of the elastic body 2) of the wave crest. Wavelength and frequency: the wavelength matches the length of the elastic body 2 (such as the wavelength is 80%-120% of the length of the elastic body 2), and the frequency is 5-30 Hz.

Preferably, the wave-like bending morphology is a complete single wave crest morphology formed by the entire elastic body 2 as a whole, specifically including: the wave crest located in the middle part of the elastic body 2 (40%-60% of the total length), with a height of wave crest being 3-5 times the thickness of the elastic body 2; the wave crest appears at a frequency of 10-30 Hz, a ratio of the wavelength to the length of the elastic body 2 is 1:1, the position of wave crest position migrates in an oscillating direction of the drive end 102, a migration speed is 0.5-2 times the length of the elastic body 2 per second, forming a continuous tapping action.

Specifically, an overall length of the drive end 102 is M, and a length of the elastic body 2 is L, which should satisfy: M≤0.5×L.

As shown in FIG. 7, yet another manifestation of the wave-like bending morphology is that the elastic body 2 generates a plurality of consecutive wave crests at the same time (similar to a multi-period waveform of the sine wave), and a number of wave crests is related to the driving frequency.

Specifically, the number of wave crests on the elastic body 2 at the same time is, for example, 2-3. A spacing between adjacent wave crests is 20%-40% of the length of the elastic body 2. The wave crest generation is synchronized with an oscillating frequency of the drive end 102 (for example, 3 peaks are generated when the driving frequency is 50 Hz).

Preferably, the wave-like bending morphology is the plurality of wave crests existing on the elastic body 2, which is specifically manifested as follows: the elastic body 2 forms 2-4 wave crests at the same time, and the spacing between adjacent wave crests is 25%-35% of the length of the elastic body 2; the height of the wave crest is 2-4 times the thickness of the elastic body 2, and the wavelength is inversely proportional to the driving frequency (for example, the wavelength decreases by 15%-20% for every 10 Hz increase in frequency); and the morphology of the plurality of wave crests changes at a frequency of 30-100 Hz, such that the tapping force is evenly applied on a target surface.

It can be foreseeable that when the elastic tapping massage structure is configured to massage a human body, such as acting on a skin surface or deeply into acupoints or other massage areas of the human body, the wave-like bending morphology generated by the elastic body 2 will continuously act on the target area, producing a stable and rhythmic tapping massage effect.

It can be foreseeable that when the elastic tapping massage structure is configured to massage a human body, such as acting on a skin surface or deeply into acupoints or other massage areas of the human body, the wave-like bending morphology generated by the elastic body 2 will continuously act on the target area, producing a stable and rhythmic tapping massage effect.

In addition, due to the inertia of the elastic body 2, the tapping force will be further increased without consuming electrical energy.

A Shore hardness of the drive end is greater than a Shore hardness of the elastic body;

where the elastic body 2 should be elastic, or at least its motion end 202 is elastic. A Shore hardness of the drive end 102 is greater than a Shore hardness of the elastic body 2, the drive end 102 needs to bear and transmit the oscillating, when its hardness is insufficient, the driving energy will be attenuated or dispersed here, making it difficult to form a clear and stable wave distribution in the elastic body 2. The elastic body 2 is relatively soft (a low hardness), the flexibility of the elastic body 2 enables it to produce sufficient deformation under the energy input from the drive end 102, thereby enabling the propagation and formation of the wave-like bending morphology. When the elastic body 2 is too hard, it will be difficult to deform significantly, and the wave-like bending morphology will be affected. When the elastic body is too soft, it may cause localized large deformation, making it impossible to form the stable wave-like bending morphology.

Therefore, the drive assembly can output a first driving frequency, and the first driving frequency drives the elastic body to form a waveform that approximates a sine wave during the oscillating motion, that is, a sine wave mode. When the motion end 202 needs to form a sine wave mode, a straight length L of the motion end in a natural extended state should be at least greater than 2 cm. In this way, when the elastic body is in the sine wave mode, the motion end 202 will exhibit a characteristic of relatively fixed distribution of antinodes and nodes. A position of the node (nodal point) of the motion end 202 is fixed, and A amplitude of the antinode is a largest, showing a wave-like vibration with a stationary waveform distribution on the whole. From a perspective of product, the sine wave mode has the following advantages:

first, compared with the single-point tapping structure in the prior art, the motion end 202 of this embodiment provides a multi-point tapping massage effect, which is more conducive to increasing the stimulation sensation during the massage;

second, for some sensitive areas, such as a G-spot, its location varies from person to person, the single-point tapping structure in the prior art is not easy to locate its position accurately, resulting in a weak massage effect on the G-spot. In contrast, by forming the plurality of wave crests, the present disclosure can more effectively locate the G-spot and deliver a more precise massage; and

third, the prior art usually adopts a rigid tapping structure, that is, a rigid drive rod is installed inside a flexible body. Although the flexible body is a structure in direct connect with a target area, the rigidity of the drive rod is indirectly transmitted to the target area, causing the massage pain of the target area. In contrast, in the present disclosure, no structure is mounted inside the motion end 202, thereby avoiding the uneven transmission of rigidity from the rigid structure, that is, the drive end 102, to the target area, and accordingly reducing the massage pain caused by local excessive rigidity and improving user comfort. No internal structure is arranged in the motion end 202, which is conducive to an overall flexibility of the elastic body 2. Through the sine wave mode, the plurality of wave crests can simultaneously provide tapping effects, such that the massage stimulation is more evenly distributed in the target area, further improving the massage experience. In addition, the energy conversion between the drive end 102 and the elastic body 2 is smoother, avoiding localized stress concentration due to rigidity transmission, and further effectively reducing a risk of fatigue and discomfort during long-term use, while improving durability and stability of the product.

As shown in FIG. 1, the motion end 202 of the elastic body 2 is a flat tapping head. The flat tapping head should be understood as having a wide and flat cross-sectional shape, that is, a width of the flat tapping head is greater than a thickness of the flat tapping head, so as to ensure a larger contact area during tapping, rather than a point-like or line-like effect. Specifically, the flat tapping head has the following characteristics:

the width W of the flat tapping head is greater than the thickness T thereof, and typically a relationship W≥2 T should be satisfied to ensure sufficient flatness, making the tapping effect more uniform.

For example, when the thickness T of the tapping head is 3 mm, the width W thereof could be at least 6 mm.

A shape of the tapping head can be rectangular, elliptical, or leaf-like, such that when the elastic body 2 presents the wave-like bending morphology, a plurality of wave crests are formed, improving the multi-point tapping effect. The shape facilitates the optimization of energy transfer, such that vibrations from the drive end 102 acts on the target area more efficiently.

Compared with traditional point-like or wand-like tapping structures, the flat tapping head can cover a larger area per unit time, making the massage effect more uniform and comfortable while avoiding discomfort caused by excessive localized pressure.

Further, when the motion end 202 vibrates, the flat tapping head helps form a stable wave-like bending morphology, such that the tapping effect in the wave crest area is more even and sustained.

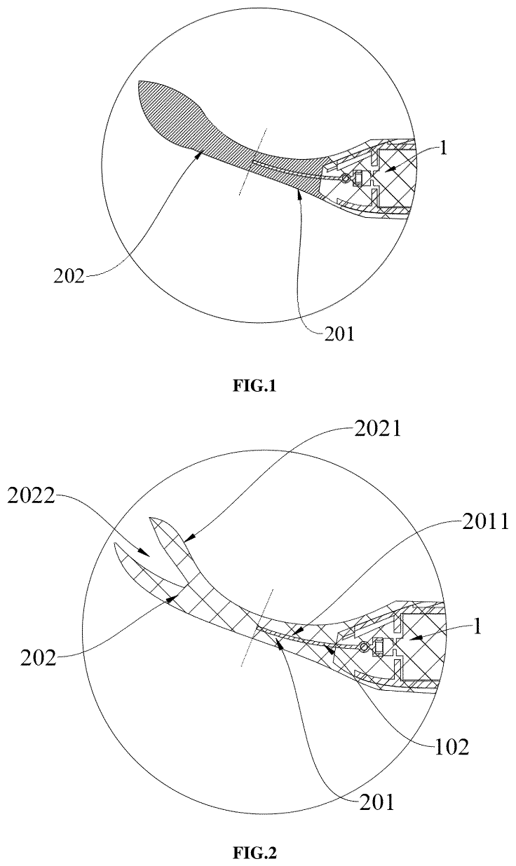

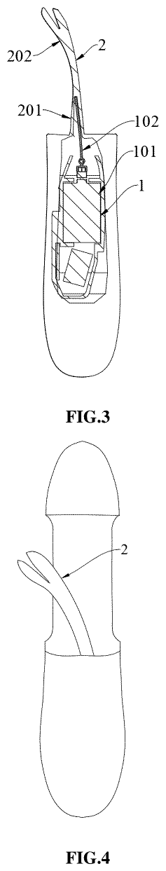

As shown in FIG. 2, the motion end 202 is sectioned into a plurality of flaps 2021 in a length direction, and a gap 2022 is formed between adjacent flaps 2021. A width direction of the flaps 2021 is perpendicular to an oscillating direction of the oscillating motion. Specifically, the motion end 202 is evenly sectioned in a length direction into a plurality of independent flaps 2021 (such as, 2-6 flaps), each flap 2021 remains the characteristics of the elastic body 2 and can produce periodic tapping with the vibrations of the drive end 102.

A gap 2022 is formed between adjacent flaps 2021, so as to ensure that each flap 2021 can move independently during the vibration while maintaining the overall flexibility of the structure. The gap 2022 should be greater than twice a maximum amplitude of the flaps 2021 (for example, when the amplitude is 5% of the length L, then G≥2×0.05 L) to avoid collision of the flaps 2021. When L=100 mm, G≥10 mm, however, in practice, consideration needs to be given to flexibility and independence, G=2-5 mm can be used as an example.

A shape of each flap 2021 can be designed as a narrow strip, arc, or leaf-like shape to optimize the fit to the target area. Ends of the flaps 2021 can be designed as a smooth transition to avoid discomfort caused by sharp edges.

The flaps 2021 are also made of elastic material, a Shore hardness (H2) of the flaps is kept to low, so as to ensure that they can conform to curved surface of the human body during the tapping process, and reduce the sensation of rigid impact.

Further, due to the gap 2022 between the flaps 2021, each flap 2021 can oscillate independently during tapping, avoiding excessive rigidity of the overall structure, improving softness, and making the massage more comfortable. Compared with an overall tapping head, the plurality of flaps 2021 can more flexibly adapt to target massage areas of different shapes (such as curved surfaces, recessed areas). Each flap 2021 forms an independent wave crest and trough when the elastic body 2 presents the wave-like bending morphology, achieving multi-point tapping and improving the stimulation effect on the area under massage.

Based on this, this embodiment is particularly suitable for locations that are difficult to precisely stimulate, such as the G-spot or sensitive areas, thereby improving the effectiveness and comfort of the massage.

In addition, due to the gaps 2022 between the flaps 2021, a slight airflow can be formed during the massage, reducing the discomfort caused by a sealed fit, and making the massage experience more breathable and natural.

The elastic body 2 is non-uniformly distributed in the length direction. Preferably, mass distribution per unit length of the elastic body 2 near the motion end 202 is greater than mass distribution per unit length at the connecting end 201. It should be understood that the motion end 202 of the elastic body 2 is heavier, and the mass distribution in the length direction is non-uniform, which is specifically manifested as: thicknesses of some areas of the motion end 202 are increased, which increases the inertia of the areas, thereby improving the tapping impact force. The localized concentration of mass improves the energy storage and release effects when the elastic body 2 presents the wave-like bending morphology, such that the tapping effect becomes stronger and deeper.

Overall, by utilizing the non-uniform mass distribution, the vibration energy is amplified in specific areas, thereby enhancing the tapping strength and effect.

A certain segment of the motion end 202 has a larger thickness T(x), such that a local mass m(x) of the segment is greater.

For example, a thickness of ordinary section: T1=2-5 mm; and a thickness of thickened segment: T2=5-10 mm.

The mass distribution can be achieved through material lamination, composite structures, or being filled with local high-density materials.

Since the area with an increased mass has greater inertia, the area will more stably maintain the tapping rhythm and release more energy at the wave crests or troughs. The inertia effect helps increase the impact force, making the tapping effect deeper and more penetrating.

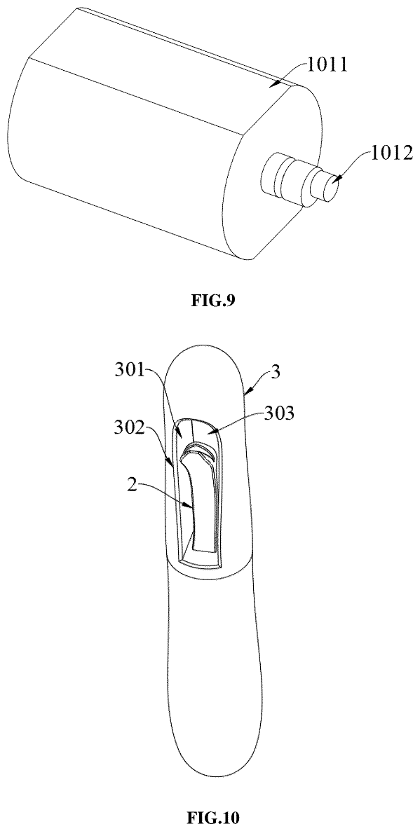

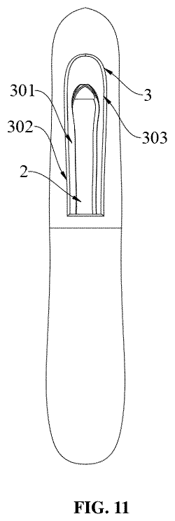

As shown in FIGS. 10 and 11, the present disclosure provides an elastic tapping massage device, including the elastic tapping massage structure described in the above embodiment.

The elastic tapping massage device is suitable for internal use.

Specifically, the elastic tapping massage device has a housing 3. A cavity 301 is formed in the housing 3, the elastic tapping massage structure is arranged inside the housing 3, and the elastic body of the elastic tapping massage structure 2 located in the cavity 301.

Specifically, the cavity 301 has a first opening 302, and the first opening 302 is formed on a circumferential side wall of the housing 3. During massage, when the elastic body 2 presents the wave-like bending morphology, a curved portion thereof can protrude from the cavity 301 through the first opening 302.

For example, in one usage scenario, when the elastic tapping massage device is inserted into the human body, and the wave crests generated by the motion end 202 continuously and intermittently protrude from the first opening 302 of the cavity 301 and are in contact with an internal cavity of the area under massage, applying the tapping massage force.

The cavity 301 also has a second opening 303. The second opening 303 is opposite to the first opening 302, such that the cavity 301 is in a fully open-through state (that is, the first opening 302 points to a direction of the second opening 303). During massage, when the elastic body 2 presents the wave-like bending morphology, the curved portion thereof can protrude from the cavity 301 through the second opening 303.

For example, in another usage scenario, when the elastic tapping massage device is inserted into the human body, the wave crests generated by the motion end 202 continuously and intermittently protrude from the first opening 302 and the second opening 303 of the cavity 301 and are in contact with an internal cavity of the area under massage, applying the tapping massage force.

In the description of the embodiments of the present disclosure, it should be understood that the terms “upper”, “lower”, “front”, “back”, “left”, “right”, “vertical”, “horizontal”, “central”, “top”, “bottom”, “top surface”, “bottom”, “inner”, “outer”, “inside”, “outside” and other indicated orientations or positional relationships are based on orientation or position relations shown in the accompanying drawings.

In the description of the embodiments of the present disclosure, it should be noted that, unless otherwise explicitly specified and defined, the terms “mounting”, “connecting”, “connection” and “assembly” should be understood in a broad sense, for example, they may be a fixed connection, a detachable connection, or an integrated connection; and may be a direct connection, or an indirect connection via an intermediate medium, or communication inside two elements. For those of ordinarily skilled in the art, specific meanings of the above terms in the present disclosure could be understood according to specific circumstances.

In the description of the embodiments of the present disclosure, specific feature, structure, material or characteristics described may be combined in a suitable manner in any one or more embodiments or examples.

In the description of the embodiments of the present disclosure, it should be understood that that “−” and “˜” represent the same range of two numerical values, and the range includes end values thereof, for example, “A-B” means a range greater than or equaling to A and less than or equaling to B. “A˜B” means a range greater than or equaling to A and less than or equaling to B.

In the description of the embodiments of the present disclosure, the term “and/or” represents merely an association relationship describing associated objects, indicating that there may be three types of relationships, for example, A and/or B, which means three types of situation, that is, the existence of A alone, the existence of both A and B, and the existence of B alone. In addition, the character “/” herein generally indicates that the associated objects are in an “or” relationship.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

What is claimed is:

1. An elastic tapping massage structure, comprising:
a drive assembly comprising a drive end, wherein the drive end is configured to perform oscillating motion;
an elastic body comprising a connecting end and a motion end; wherein the connecting end is coupled with the drive end; and
the oscillating motion of the drive end causes the elastic body to present a wave-like bending morphology in an axial direction of the elastic body.

2. The elastic tapping massage structure according to claim 1, wherein
the motion end of the elastic body is a flat tapping head.

3. The elastic tapping massage structure according to claim 2, wherein p1 the motion end is sectioned into a plurality of flaps in a length direction, and a gap is formed between adjacent flaps.

4. The elastic tapping massage structure according to claim 3, wherein
a width direction of the flaps is perpendicular to an oscillating direction of the oscillating motion.

5. The elastic tapping massage structure according to claim 3, wherein
a number of the flaps is 2, and each flap is flap-shaped.

6. The elastic tapping massage structure according to claim 1, wherein
a Shore hardness of the drive end is greater than a Shore hardness of the elastic body.

7. The elastic tapping massage structure according to claim 1, wherein
mass distribution per unit length of the elastic body near the motion end is greater than mass distribution per unit length of the connecting end.

8. The elastic tapping massage structure according to claim 1, wherein
the motion end is a free end.

9. The elastic tapping massage structure according to claim 1, wherein the drive assembly outputs:
a first driving frequency; and
the first driving frequency drives the elastic body to form a waveform that approximates a sine wave during the oscillating motion.

10. The elastic tapping massage structure according to claim 9, wherein
the waveform that approximates a sine wave has at least 2 wave crests.

11. The elastic tapping massage structure according to claim 1, wherein
a length of the elastic body is at least 2 cm.

12. The elastic tapping massage structure according to claim 1, wherein the drive assembly comprises:
a drive motor and an eccentric connecting structure, wherein an operating end of the drive motor is connected to the eccentric connecting structure; and
the eccentric connecting structure is connected to the drive end.

13. The elastic tapping massage structure according to claim 12, wherein the eccentric connecting structure is an eccentric cam.

14. The elastic tapping massage structure according to claim 12, wherein the drive end is a sheet structure; and
the sheet structure is arranged as a curvature.

15. The elastic tapping massage structure according to claim 14, wherein the drive end comprises:
a first end and a second end; wherein
the first end is an end away from the drive motor;
the second end is an end near the drive motor; and
the second end is connected to the eccentric cam.

16. The elastic tapping massage structure according to claim 15, wherein the second end is provided with a coupling slot that slides in cooperation with the eccentric cam.

17. The elastic tapping massage structure according to claim 15, wherein the drive end is provided with a hinged portion, and the hinged portion comprises:
a mounting hole and a rotating shaft; wherein
the mounting hole is formed at a position near the second end; and
the rotating shaft is rotatably connected to the mounting hole.

18. The elastic tapping massage structure according to claim 11, wherein
an overall length of the drive end is at most half the length of the elastic body.

19. An elastic tapping massage device, comprising:
a drive assembly comprising a drive end, wherein the drive end is configured to perform oscillating motion;
an elastic body comprising a connecting end and a motion end; wherein
the connecting end is coupled with the drive end;
the oscillating motion of the drive end causes the elastic body to present a wave-like bending morphology in an axial direction of the elastic body;
a cavity having a first opening is formed on the housing; and
the elastic body is arranged in the cavity; wherein
when the elastic body presents the wave-like bending morphology, a curved portion of the elastic body protrudes from the cavity through the first opening.

20. The elastic tapping massage device according to claim 19, wherein
the cavity has a second opening; wherein
when the elastic body presents the wave-like bending morphology, the curved portion of the elastic body protrudes from the cavity through the second opening.
